(19) United States
(12) Patent Application Publication
(10) Pub. No.: US 2018/0373852 A1
(43) Pub. Date: Dec. 27, 2018

(54) ROBOT CONTROL SYSTEM

(71) Applicant: FUJI XEROX CO., LTD., Tokyo (JP)

(72) Inventors: Hirokazu TSUBOTA, Kanagawa (JP); Kunitoshi YAMAMOTO, Kanagawa (JP); Tsutomu ISHII, Kanagawa (JP); Hideto NOMIYAMA, Kanagawa (JP); Hideki FUJIMOTO, Kanagawa (JP)

(73) Assignee: FUJI XEROX CO., LTD., Tokyo (JP)

(21) Appl. No.: 15/814,686

(22) Filed: Nov. 16, 2017

(30) Foreign Application Priority Data
Jun. 26, 2017 (JP) 2017-124222

(51) Int. Cl. G06F 21/30; B25J 9/00; B25J 9/16; G05D 1/00

(52) U.S. Cl. CPC G06F 21/305; G05D 1/0016; B25J 9/1602; B25J 9/0003

(57) ABSTRACT

A robot control system includes a remotely operated robot, a receiver, and an authority granting unit. The remotely operated robot have plural functions. The permission unit is configured to only permit a user having an operation authority for a specific function to remotely operate the specific function, among plural users who remotely operate the remotely operated robot. The receiver is configured to receive a permission request for remotely operating the specific function from a user who does not have the operation authority for the specific function, among the users who remotely operate the remotely operated robot. The authority granting unit is configured to grant the operation authority for the specific function to the user who has made the permission request, if a predetermined condition is satisfied upon receiving the permission request.

### CROSS-REFERENCE TO RELATED APPLICATIONS

This application is based on and claims priority under 35 USC 119 from Japanese Patent Application No. 2017-124222 filed Jun. 26, 2017.

### BACKGROUND

### Technical Field

The present invention relates to a robot control system.

### SUMMARY

According to an aspect of the invention, a robot control system includes a remotely operated robot, a receiver, and an authority granting unit. The remotely operated robot have plural functions. The permission unit is configured to only permit a user having an operation authority for a specific function to remotely operate the specific function, among plural users who remotely operate the remotely operated robot. The receiver is configured to receive a permission request for remotely operating the specific function from a user who does not have the operation authority for the specific function, among the users who remotely operate the remotely operated robot. The authority granting unit is configured to grant the operation authority for the specific function to the user who has made the permission request, if a predetermined condition is satisfied upon receiving the permission request.

### BRIEF DESCRIPTION OF THE DRAWINGS

Exemplary embodiments of the present invention will be described in detail based on the following figures, wherein:

FIG. 1 is a schematic diagram illustrating an example of a robot control system according to an exemplary embodiment of the present invention;

FIG. 2 is a hardware configuration diagram of a telepresence robot according to the exemplary embodiment of the present invention;

FIG. 3 is a functional block diagram of the telepresence robot according to the exemplary embodiment of the present invention;

FIG. 4 is a view illustrating an example of an operation authority listing database according to the exemplary embodiment of the present invention;

FIG. 5 is a hardware configuration diagram of a remote operation terminal device according to the exemplary embodiment of the present invention;

FIG. 6 is a functional configuration diagram of the remote operation terminal device according to the exemplary embodiment of the present invention;

FIG. 7 is a flowchart illustrating a flow of a process of temporarily granting an authority to remotely operate a specific function of the telepresence robot according to the exemplary embodiment of the present invention;

FIG. 8 is a view illustrating the continuation of the flowchart of FIG. 7;

FIG. 9A is a view illustrating an example of a display screen displayed on a display device that constitutes a user interface of a first remote operation terminal device;

FIG. 9B is a view illustrating an example of an information input screen for requesting permission of a temporary remote operation;

FIG. 10A is a view illustrating an example of a temporary operation authority permission confirmation screen displayed on a display device of a second remote operation terminal device;

FIG. 10B is a view illustrating an example of a permission period setting screen displayed on the display device of the second remote operation terminal device;

FIG. 11A is a view illustrating an example of a temporary remote operation screen, for temporarily remotely operating a moving device and a movement controller of the telepresence robot, displayed on the display device of the first remote operation terminal device; and

FIG. 11B is a view illustrating an example of a temporary remote operation ending screen indicating that the temporary remote operation of the movement controller is invalidated.

### DETAILED DESCRIPTION

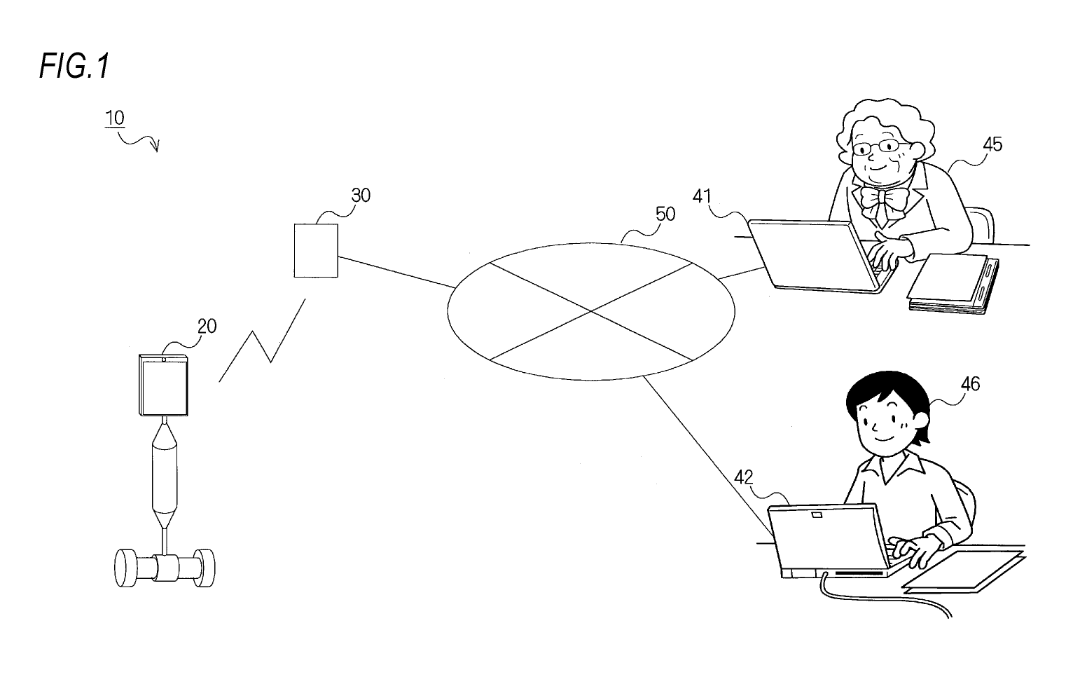

Exemplary embodiments of the present invention will be described in detail with reference to the accompanying drawings. FIG. 1 is a schematic diagram illustrating an example of a robot control system 10 of the present exemplary embodiment. As illustrated in FIG. 1, the robot control system 10 of the present exemplary embodiment includes a single telepresence robot (remotely operated robot) 20 having plural functions and at least two remote operation terminal devices (a first remote operation terminal device 41 and a second remote operation terminal device 42; which may be referred to as a remote operation terminal device 40 when the two remote operation terminal devices are collectively mentioned). The telepresence robot 20 is connected to a network 50 in a wireless manner through an access point 30 installed at a site such as a factory, a hospital, an examination site, and other facilities where a desired work is performed as the telepresence robot 20 is remotely operated. Further, the remote operation terminal device terminals 40 are connected to the network 50.

With this configuration, the plural functions (for example, a movement control function and a camera function) of the telepresence robot 20 are remotely operated by the two remote operation terminal devices 40. The first remote operation terminal device 41 is operated by a first remote operator 45. The second remote operation terminal device 42 is operated by a second remote operator 46. Normally, the plural functions of the telepresence robot 20 may be remotely operated by plural remote operators, respectively, at the same time. For example, the respective remote operators may exclusively, remotely, and simultaneously operate the respective functions in such a manner that while the first remote operator 45 remotely operates the movement control function of the telepresence robot, the second remote operator 46 remotely operates the functions except for the movement control function, for example, the camera function. Of course, if any one of the functions is set to accept the remote operations from the two or more remote operators, the remote operations from the plural remote operators may be simultaneously accepted.

With reference to FIG. 1, descriptions have been made on the example in which the two remote operation terminal devices 40 are connected to the single telepresence robot 20. It should be noted that the exemplary embodiment of the present invention is also applicable to a case where three or more remote operation terminal devices 40 are provided. In the present exemplary embodiment, the “remote operation (remotely operate)” means that the functions of the telepresence robot 20 are controlled by operating the remote operation terminals 40 connected to the telepresence robot 20. In addition, here, the “simultaneous remote operation (simultaneously remotely operate)” means that periods of time for which the plural functions are remotely operated by plural users overlap with each other.

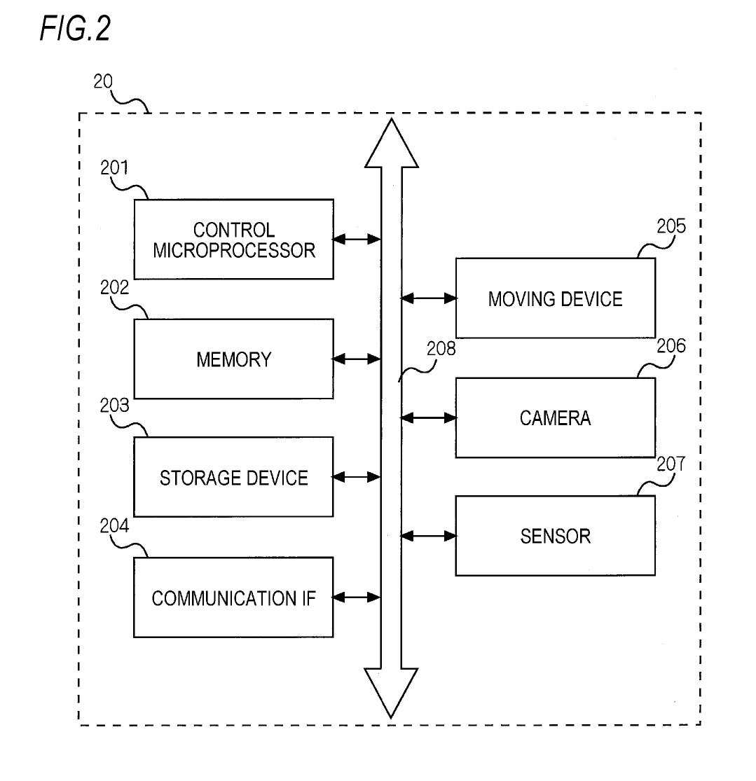

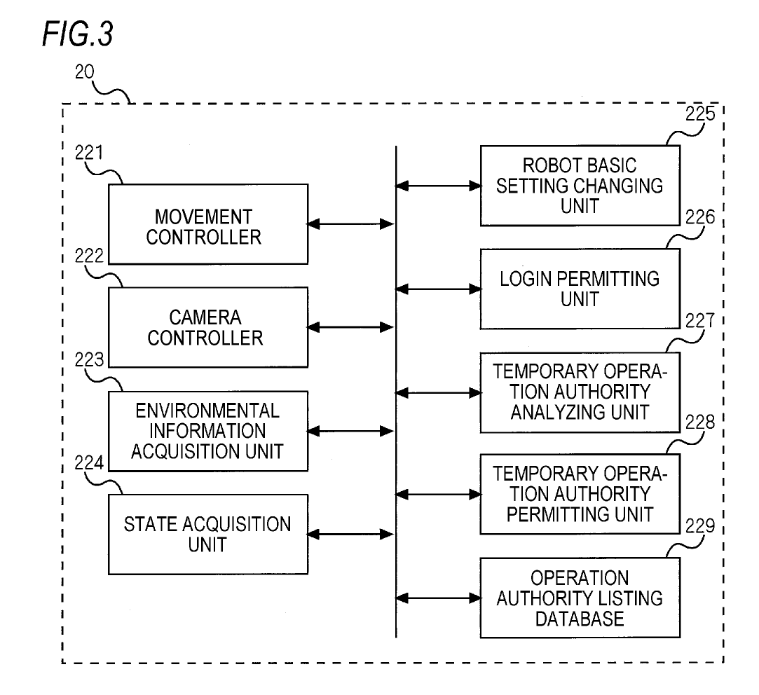

Next, the telepresence robot 20 according to the present exemplary embodiment will be described with reference to FIGS. 2 and 3. FIG. 2 is a hardware configuration diagram of the telepresence robot 20 according to the present exemplary embodiment. As illustrated in FIG. 2, the telepresence robot 20 includes a control microprocessor 201, a memory 202, a storage device 203, a communication interface 204, a moving device 205, a camera 206, and a sensor 207 which are connected to a control bus 208.

The control microprocessor 201 collectively controls operations of the respective parts of the telepresence robot 20 based on a control program stored in the storage device 203. The memory 202 stores image data captured by the camera 206, and environmental information and voice information detected by the sensor 207. In addition, login states of the plural remote operation terminal devices 40 are stored in the memory 202 in real time.

The storage device 203 is configured with a hard disk drive (HDD) or a solid state drive (SSD). The storage device 203 stores the control program for controlling the respective parts of the telepresence robot 20, and images and recorded videos captured by the camera 206 which will be described later. Further, the storage device 203 stores robot basic setting information such as a prescribed traveling velocity of the telepresence robot 20, a display setting in a case where a user interface is provided, a volume setting of a speaker in a case where the speaker is provided, a voice detection intensity of a microphone, and an automatic power supply setting. Further, the storage device 203 stores login information of the first remote operator 45 and the second remote operator 46 who may log in the telepresence robot 20 by using the remote operation terminal devices 40 to remotely operate the telepresence robot 20.

The communication interface 204 performs communication control in order to allow the telepresence robot 20 to communicate with the plural remote operation terminal devices 40 through the access point 30.

The moving device 205 includes tires, a motor, a gear shifting mechanism, a brake, a direction control device, and a current position detecting device. The movement of the moving device 205 is controlled by a movement controller which will be described later, to cause the telepresence robot 20 to move forward and rearward, stop, and change a direction of the telepresence robot 20.

The camera 206 includes various types of image capturing devices such as a main camera, a side camera, an obstacle detecting camera, and an infrared camera (thermography). The main camera is mainly used when the telepresence robot 20 travels. The main camera monitors surroundings of the telepresence robot 20. The captured image is temporarily stored in the memory 202. The side camera captures an image of the surroundings of the telepresence robot 20 and an image of an object in a specific region. The captured images or videos are stored in the memory 202 or the storage device 203. The obstacle detecting camera is attached to a lower portion of the telepresence robot 20. The obstacle detecting camera detects an obstacle around the telepresence robot 20. The image captured by the obstacle detecting camera is temporarily stored in the memory 202, and used as information in order for the telepresence robot 20 to autonomously stop or avoid an obstacle. The infrared camera captures a temperature state of a structure around the telepresence robot 20. The captured temperature state is stored, as an image or a video, in the memory 202 or the storage device 203.

The sensor 207 includes an environmental sensor module configured with a temperature sensor, a humidity sensor, an illumination intensity sensor, a vibration sensor, and a noise level meter, and a microphone. The environment information and the voice information such as temperature, humidity, an illumination intensity, vibration, and a noise level detected by the environment sensor and the microphone are temporarily stored in the memory 202, or accumulated in the storage device 203.

FIG. 3 is a functional block diagram of the telepresence robot 20 of the present exemplary embodiment. As illustrated in FIG. 3, the telepresence robot 20 serves as a movement controller 221, a camera controller 222, an environment information acquisition unit 223, a state acquisition unit 224, a robot basic setting changing unit 225, a login permitting unit 226, a temporary operation authority analyzing unit 227, a temporary operation authority permitting unit 228, and an operation authority listing database 229 by executing the control program stored in the storage device 203 through the control microprocessor 201.

The movement controller 221 controls the moving device 205 based on remote movement control information received from the remote operation terminal device 40 to cause the telepresence robot 20 to move forward and rearward, stop, and changes the direction.

The camera controller 222 controls angle adjustment and focal point adjustment of the camera 206 based on remote camera control information received from the remote operation terminal device 40. In addition, the camera controller 222 activates the infrared camera and acquires captured images based on the remote camera control information received from the remote operation terminal device 40.

The environment information acquisition unit 223 acquires, from the memory 202, the temporary record of the environment information and the voice information around the telepresence robot 20 such as a temperature, a humidity, an illumination intensity, vibration, and a noise level detected by the sensor 207, or the environment information acquisition unit 223 acquires, from the storage device 203, the record of the environment information and the voice information within a predetermined period of time.

The state acquisition unit 224 acquires an internal state of the robot such as remaining battery charge, an internal temperature, equipped function information, failure function information, and a reservation situation of the telepresence robot 20. The state acquisition unit 224 transmits the acquired information to the remote operation terminal device 40 which has an information acquisition authority and which has requested information acquisition.

The robot basic setting changing unit 225 changes a setting value of the robot basic setting information stored in the storage device 203, and stores the changed setting value in the storage device 203. For example, the robot basic setting changing unit 225 changes a prescribed traveling velocity of the telepresence robot 20, a display setting of the user interface in a case where the user interface is provided in the telepresence robot 20, a sound volume of the speaker, a voice detection sensitivity of the microphone, and a setting value of the automatic power supply setting.

The login permitting unit 226 receives login information from the remote operation terminal device 40 and compares the received login information with the login information stored in the storage device 203. If the received login information is valid, the login permitting unit 226 permits, referring to the operation authority listing database 229, a remote operator who performs the login, that is, a remote operator having an operation authority for a specific function to remotely operate the specific function corresponding to a general operation authority that a remote operator who performs the login has. Therefore, in a case where the telepresence robot 20 has plural functions, the login permitting unit 226 simultaneously permits different remote operators having operation authorities to remotely operate the plural functions, respectively.

Here, “the simultaneous permission of the remote operations (simultaneously permit someone to remotely operate)” means that periods of time for which the remote operations of the respective plural functions are permitted overlap with each other. For example, “the simultaneous permission of the remote operations (simultaneously permit someone to remotely operate)” means that when the first remote operator remotely controls the movement controller, the second remote operator concurrently and remotely controls the camera.

The temporary operation authority analyzing unit 227 receives a permission request for temporarily granting an operation authority to remotely operate a specific function from a remote operator who does not have the operation authority for the specific function among the remote operators who remotely operate the telepresence robot 20 by operating the remote operation terminal devices 40 (hereinafter, referred to as a “temporary operation authority permission request”). When receiving the temporary operation authority permission request from the remote operation terminal device 40, the temporary operation authority analyzing unit 227 determines whether the remote operator who has made the temporary operation authority permission request satisfies a predetermined condition regarding the specific function, referring to the operation authority listing database 229. If the remote operator satisfies the predetermined condition, the temporary operation authority analyzing unit 227 transmits a confirmation request as to whether to permit a temporal remote operation (hereinafter, referred to as a “temporary operation authority permission confirmation request”), to the remote operation terminal device 40 operated by a remote operator who has an authority to change the operation authority, referring to the operation authority listing database 229. Further, when receiving a reply indicating rejection of the temporary operation authority permission confirmation request from the remote operation terminal device 40 operated by the remote operator who has the change authority for the operation authority, the temporary operation authority analyzing unit 227 transmits information indicating that the temporary operation authority for the specific function is not permitted, to the remote operation terminal device 40 which has made the temporary operation authority permission request.

When receiving information indicating permission of granting of the temporary operation authority from the remote operation terminal device 40 operated by the remote operator who has the change authority in response to the temporary operation permission confirmation request, the temporary operation authority permitting unit 228 permits the remote operation terminal device 40 which has made the temporary operation authority permission request to temporarily remotely operate the specific function, thereby granting the operation authority for the specific function to the remote operator who operates the remote operation terminal device 40 and accepting the remote operation by this remote operator. In this case, the temporary operation authority permitting unit 228 permits the operation authority for the specific function by the remote operator who operates the remote operation terminal device 40 which has made the temporary operation authority permission request, only for a predetermined period of time. The temporary operation authority permitting unit 228 invalidates the operation authority after the predetermined period of time, thereby prohibiting the remote operation of the specific function. The predetermined period of time may be designated by the remote operator who has the change authority for the specific function in response to the temporary operation permission confirmation request. Alternatively, the predetermined period of time may be registered in advance in the operation authority listing database 229 of the telepresence robot 20.

The temporary operation authority permitting unit 228 may simultaneously grant the operation authority for the specific function of the telepresence robot 20 to different users. Here, “simultaneously grant the operation authority” means that when the operation authority for the same specific function is granted to plural remote operators, periods of time for which the operation authority is granted to two or more remote operators overlap with each other. In addition, the temporary operation authority permitting unit 228 may grant the operation authority for the specific function of the telepresence robot 20 to the remote operator who does not have the operation authority originally. As a result, the specific function of the telepresence robot 20 maybe remotely operated by the plural users at the same time. Here, the phrase “the specific function of the telepresence robot 20 maybe remotely operated at the same time” means that periods of time for which the same specific function is operable by the remote operator who has the operation authority originally and another remote operator (one or more remote operators) who is granted the operation authority temporarily granted by this remote operator overlap with each other.

The temporary operation authority permitting unit 228 may be configured such that (i) if the telepresence robot 20 is present in a predetermined region, the temporary operation authority permitting unit 228 permits the remote operator who operates the remote operation terminal device 40 which has transmitted the temporary operation permission confirmation request, to remotely operate the specific function and (ii) if the telepresence robot 20 is out of the predetermined region, the temporary operation authority permitting unit 228 prohibits the remote operator from remotely operating the specific function. Alternatively, if the telepresence robot 20 is present out of the predetermined region, the temporary operation authority permitting unit 228 may permit the remote operator who operates the remote operation terminal device 40 which has transmitted the temporary operation permission confirmation request, to remotely operate the specific function. If the telepresence robot 20 is present in the predetermined region, the temporary operation authority permitting unit 228 may prohibit the remote operator from remotely operating the specific function. Further, if the temporary remote operation is performed and if the telepresence robot 20 is about to come out of the predetermined region, the temporary operation authority permitting unit 228 may prohibit the remote operation of the movement controller 221. This predetermined region may be determined for each function or for each remote operator and registered in the operation authority listing database 229 which will be described later.

The operation authority listing database 229 is a database in which a list of operation authorities for respective functions of the telepresence robot 20 are registered. The list of operation authorities includes remote operators having change authorities, remote operators having general operation authorities, conditions and qualifications to grant the temporary operation authorities, and types of use to grant of the temporary operation authority. In addition, as described above, the predetermined region to permit granting of the temporary operation authorities may be registered for each function or for each remote operator.

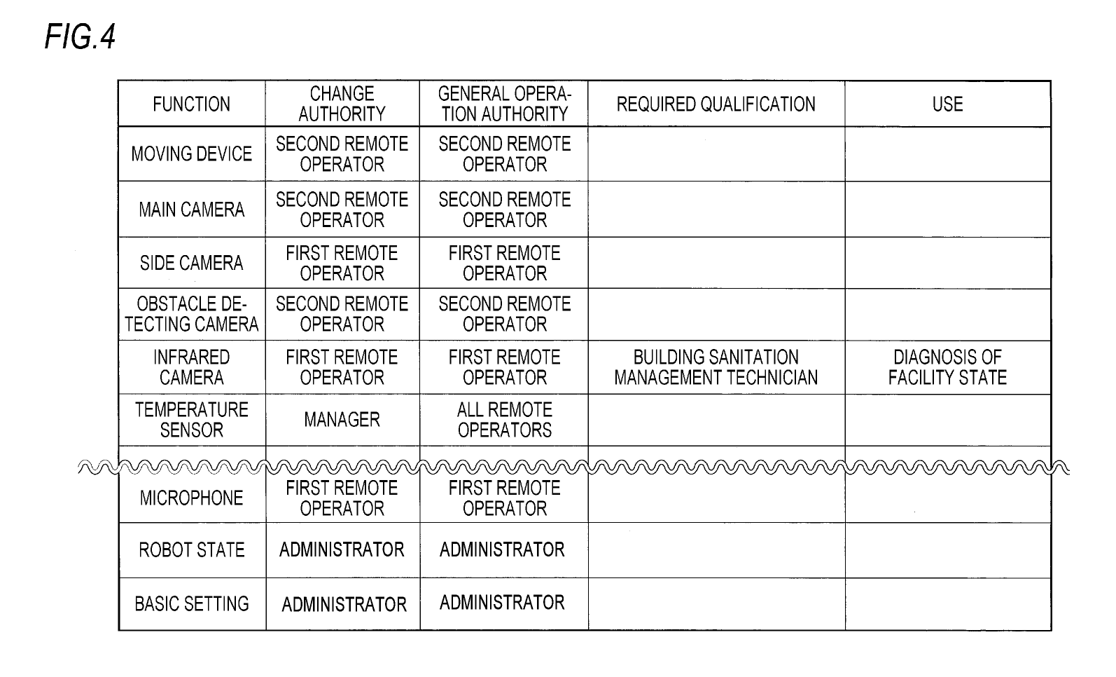

FIG. 4 illustrates an example of the operation authority listing database 229. Plural functions of the telepresence robot, persons having the change authorities for the plural functions, persons having general operation authorities, and conditions (for example, required qualification and use for permitting an operation) when the temporary remote operation is permitted are registered in the operation authority listing database 229. For example, the “second remote operator” has the “change authority” for the “moving device” and the “general operation authority” for the “moving device”, and the “first remote operator” has the “change authorities” for the “side camera” and the “infrared camera” and the “general operation authority” for the “side camera” and the “infrared camera” In addition, a “building sanitation management technician” is registered as the qualification required for the “infrared camera,” and a “diagnosis of a facility state” is registered as the “use” for permitting an operation.

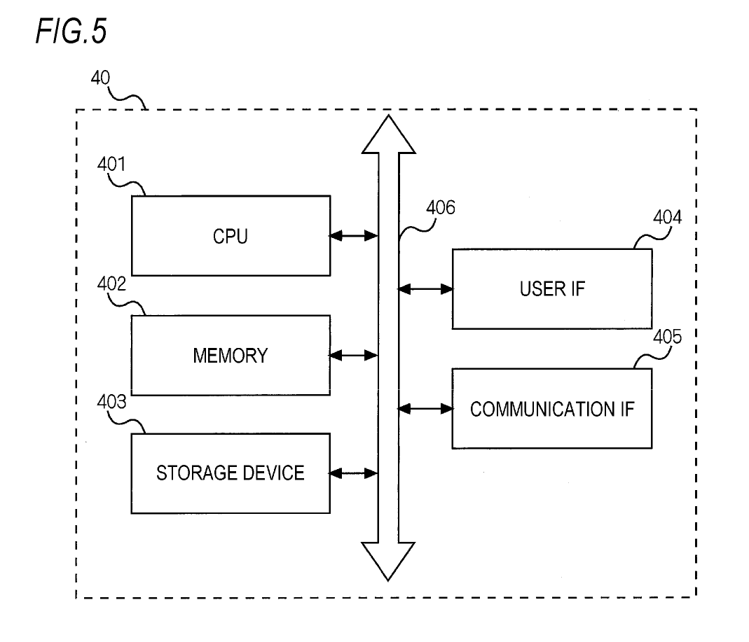

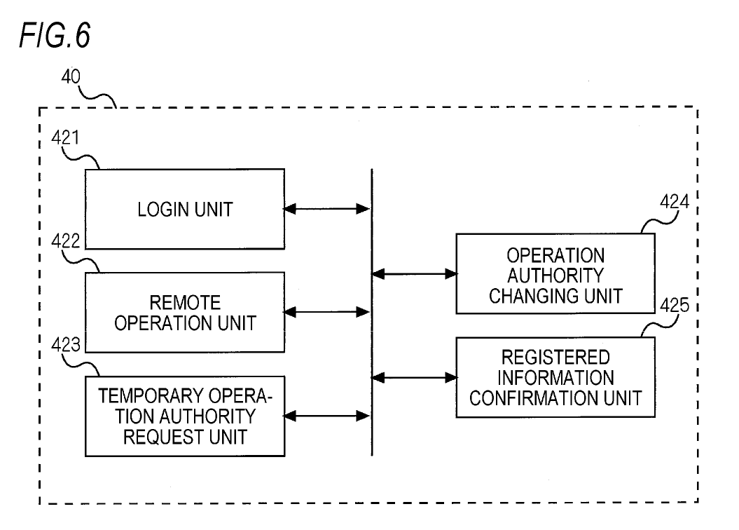

Next, the remote operation terminal device 40 of the present exemplary embodiment will be described with reference to FIGS. 5 and 6. The first remote operation terminal device 41 and the second remote operation terminal device 42 have the same configuration. Thus, the first remote operation terminal device 41 and the second remote operation terminal device 42 will be described as the remote operation terminal device 40 below, like reference numerals are assigned to respective constituent elements thereof, and the descriptions will be made. FIG. 5 illustrates a hardware configuration of the remote operation terminal device 40 according to the present exemplary embodiment.

As illustrated in FIG. 5, the remote operation terminal device 40 includes a CPU 401, a memory 402, a storage device 403, a user interface 404, and a communication interface 405 which are connected to a control bus 406.

The CPU 401 collectively controls operations of the respective parts of the remote operation terminal device 40 based on a control program stored in the storage device 403.

The memory 402 temporarily stores login information when the login is performed on the telepresence robot 20 from the remote operation terminal device 40, information of the temporary operation authority permission request when the granting of the temporary remote operation authority is requested, and remote movement control information and remote camera control information when remotely operating the telepresence robot 20.

The storage device 403 is configured with a hard disk drive (HDD) or a solid state drive (SSD). The storage device 403 stores the control program for controlling the respective parts of the remote operation terminal device 40 and an application program for generating and transmitting remote control information such as the remote movement control information and the remote camera control information for remotely operating the telepresence robot 20.

The user interface 404 includes a display device such as a liquid crystal monitor and an input device such as a keyboard, a mouse, a joystick, and a touch pad. The display device displays a login screen when login is performed on the telepresence robot 20, and images around the camera which are captured by the camera of the telepresence robot 20. The input device receives login information when the remote operation terminal device 40 logs in the telepresence robot 20 to be remotely operated. The input device is used to perform the remote operation to move the telepresence robot 20 and control the camera.

The communication interface 405 connects the remote operation terminal device 40 and the telepresence robot 20 through the network 50, and performs communication control for performing communication.

FIG. 6 is a functional block diagram of the remote operation terminal device 40. As illustrated in FIG. 6, the remote operation terminal device 40 serves as a login unit 421, a remote operation unit 422, a temporary operation authority request unit 423, an operation authority changing unit 424, and a registered information confirmation unit 425 by executing the control program and the application program stored in the storage device 403.

The login unit 421 displays an input screen that requests an input of login information to the display device that constitutes the user interface 404 of the remote operation terminal device 40. If the remote operators 45, 46 input the login information through the user interface 404, the login unit 421 transmits the input login information to the telepresence robot 20. When the login is permitted by the login permitting unit 226 of the telepresence robot 20, the login unit 421 of the remote operation terminal device 40 displays a message indicating that the login is successful, on the display device that constitutes the user interface 404, and the login unit 421 brings the remote operation terminal device 40 into a state where the remote operation, by the remote operators 45, 46 who operate the remote operation terminal devices 40, of the specific function of the telepresence robot 20 may be received.

When the remote operator operates the input device of the user interface 404 of the remote operation terminal device 40, the remote operation unit 422 generates the remote control information for remotely operating various functions of the telepresence robot 20, and remotely operates the functions such as traveling control of the telepresence robot 20, camera control, sensor control, acquisition of a robot state, and a change in robot basic setting.

More specifically, the remote operation unit 422 generates the remote movement control information for causing the telepresence robot 20 to move forward and rearward, stop, and change the direction as the remote operator operates the user interface 404, and the remote operation unit 422 transmits the generated remote movement control information to the telepresence robot 20. In addition, the remote operation unit 422 generates the remote camera control information for controlling the angle adjustment and the focal point adjustment of the camera 206 of the telepresence robot 20 as the remote operator operates the user interface 404, and the remote operation unit 422 transmits the generated remote camera control information to the telepresence robot 20. The remote camera control information also includes information for instructing activation of the infrared camera and acquisition of the captured image.

Further, in response to an operation of the user interface 404, the remote operation unit 422 generates a sensor information acquisition request for instructing acquisition of (i) temporary record of environment information and voice information such as a temperature, a humidity, an illumination intensity, vibration, and a noise level of the telepresence robot 20 or (ii) record of voice information within a predetermined period of time, and the remote operation unit 422 transmits the generated sensor information acquisition request to the telepresence robot 20. Further, in response to an operation of the user interface 404, the remote operation unit 422 generates a robot state acquisition request for acquiring a robot state such as remaining battery charge, an internal temperature, equipped function information, failure function information, and a reservation situation of the telepresence robot 20, and the remote operation unit 422 transmits the robot state acquisition request to the telepresence robot 20.

In response to an operation of the user interface 404, the remote operation unit 422 generates basic setting changing instruction information for changing basic settings such as the prescribed traveling velocity of the telepresence robot 20, a display setting in a case where a user interface is provided in the telepresence robot 20, a sound volume of a speaker, voice detection sensitivity of a microphone, and a setting value of the automatic power supply setting, and the remote operation unit 422 transmits the generated basic setting changing instruction information to the telepresence robot 20.

When the remote operator who operates the remote operation terminal device 40 wishes to remotely operate other functions of the telepresence robot 20 beyond a scope of the general operation authority, the temporary operation authority request unit 423 displays an information input screen for requesting the permission of the temporary remote operation on the display device in response to a remote operator's operation of the input device of the user interface 404. Then, the temporary operation authority request unit 423 requests an input of required user information, task contents, purposes, and reasons, and transmits the input information, as the temporary operation authority permission request, to the telepresence robot 20.

When receiving the temporary operation authority permission confirmation request from the telepresence robot 20, the operation authority changing unit 424 displays user information, task contents, purposes, reasons, and the like, which are included in the temporary operation authority permission confirmation request, on the display device of the user interface 404, and also displays, on the display device of the user interface 404, a temporary operation authority permission confirmation screen for inquiring about whether to permit the remote operator who has made the temporary operation authority permission confirmation request to perform the temporary remote operation. If the remote operator who has the change authority permits granting of the temporary operation authority by operating the user interface 404, the operation authority changing unit 424 further displays a permission period setting screen for requesting an input of a validity period of the temporary remote operation on the display device. Then, the operation authority changing unit 424 transmits permission and validity period information of the temporary remote operation to the telepresence robot 20 in response to the input of the remote operator having the change authority. If the remote operator having the change authority inputs, by the user interface 404, information indicating that he/she does not permit the temporary remote operation, the operation authority changing unit 424 transmits the information indicating that the acquisition of the temporary operation authority is rejected, to the telepresence robot 20.

The registered information confirmation unit 425 transmits a request for acquisition of a list of registered information to the telepresence robot 20. When receiving the list of the registered information from the telepresence robot 20 in response, the registered information confirmation unit 425 displays the list of the registered information on the display device of the user interface 404. The list of the registered information may be a list of ones that are required and selected from the information registered in the operation authority listing database 229. In addition, the list of the registered information may be a list made by listing the list of the remote operators who have logged in the telepresence robot 20 at the current point in time and the general operation authorities permitted to the respective remote operators. In addition, operation authority changing icons with respect to the respective remote operators may be displayed on the list of the registered information. If the remote operator selects the operation authority changing icon, the operation authority of the corresponding remote operator may be temporarily changed by the operation authority changing unit 424.

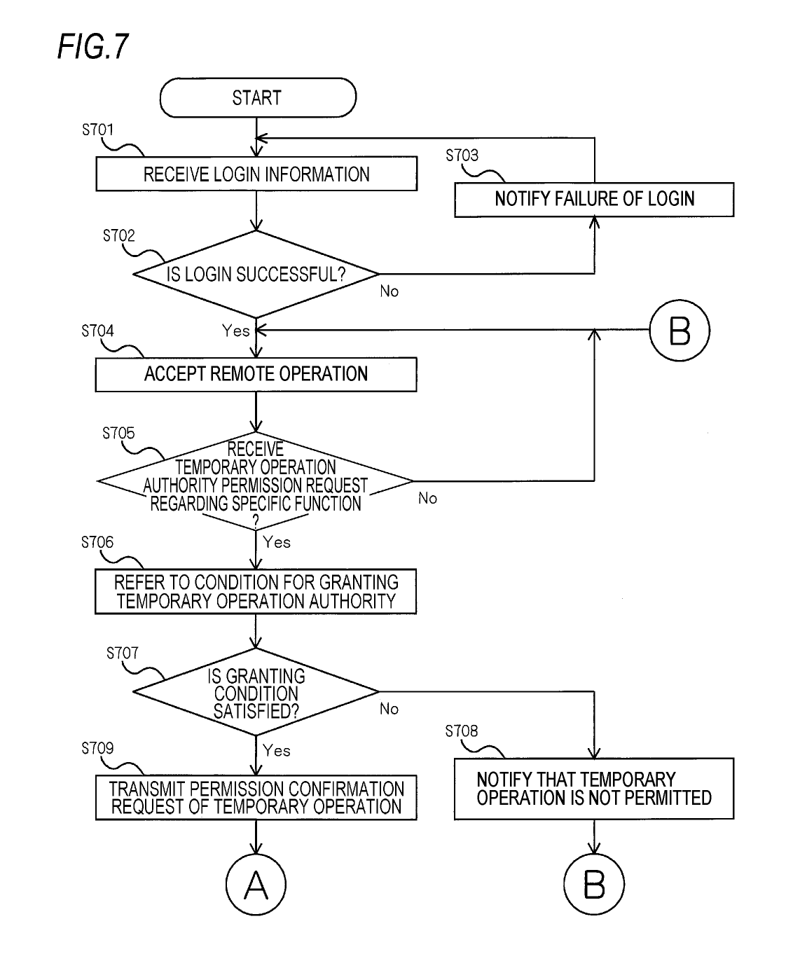

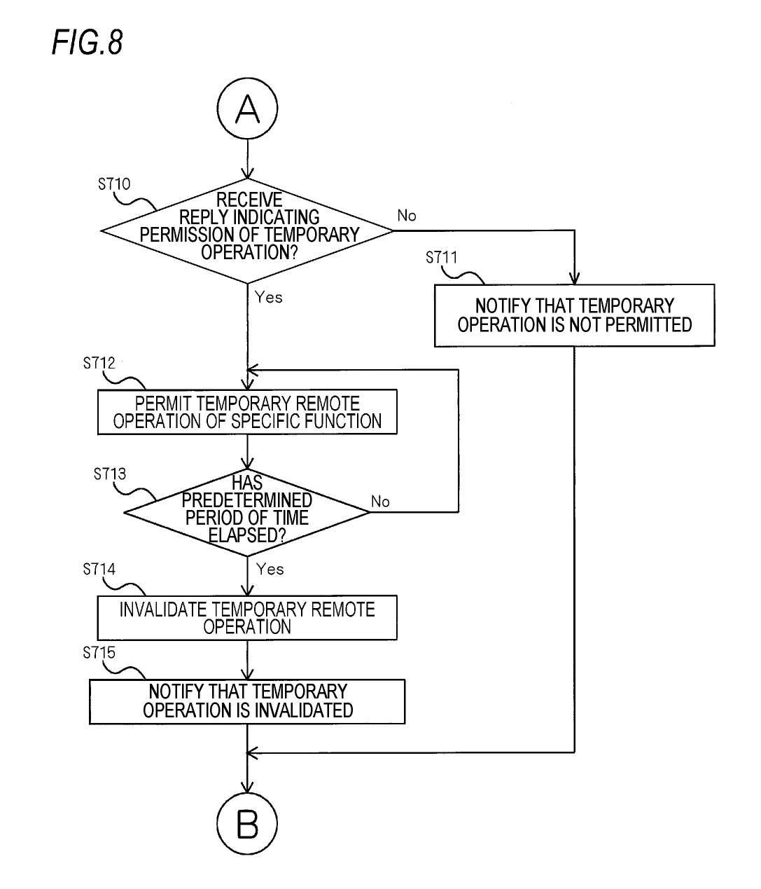

Next, a flow of a process regarding the granting of the temporary remote operation authority for the specific function according to the present exemplary embodiment will be described with reference to FIG. 7 to FIG. 11B. FIGS. 7 and 8 are flowcharts illustrating a flow of a process of temporarily granting an authority to remotely operate a specific function of the telepresence robot 20. Further, in the following example, it is assumed that the first remote operator 45 who operates the first remote operation terminal device 41 has the general operation authority to remotely operate the camera 206 of the telepresence robot 20 at a normal time, and that as necessary, the first remote operator 45 requests the temporary operation authority to temporarily remotely operate the movement controller 221 that controls the moving device 205 of the telepresence robot 20. In addition, it is assumed that the second remote operator 46 who operates the second remote operation terminal device 42 has the change authority to determine whether to permit the temporary remote operation of the movement controller 221.

In step S701, the login permitting unit 226 of the telepresence robot 20 receives login information from the first remote operation terminal device 41 and the second remote operation terminal device 42.

In step S702, the login permitting unit 226 compares the login information received from the first remote operation terminal device 41 and the second remote operation terminal device 42 with the login information stored in the storage device 203 and determines whether the login is valid. If the login information is invalid, the process goes to step S703. If the login information is valid, the process goes to step S704.

In step S703, the login permitting unit 226 transmits a message indicating that the login is failed, to the first remote operation terminal device 41 or the second remote operation terminal device 42 which has transmitted the login information. Then, the process goes back to step S701.

In step S704, the login permitting unit 226 accepts the remote operation of the functions corresponding to the general operation authorities that the first remote operator 45 or the second remote operator 46 has who remotely operates the first remote operation terminal device 41 or the second remote operation terminal device 42 which has transmitted the login information, referring to the operation authority listing database 229. Further, in the present exemplary embodiment, the login permitting unit 226 accepts the remote operation of the camera controller 222 to remotely operate the side camera and the infrared camera from the first remote operation terminal device 41 operated by the first remote operator 45. Also, the login permitting unit 226 accepts the remote operation of the movement controller 221 for controlling the moving device 205 and the remote operation of the main camera from the second remote operation terminal device 42 operated by the second remote operator 46.

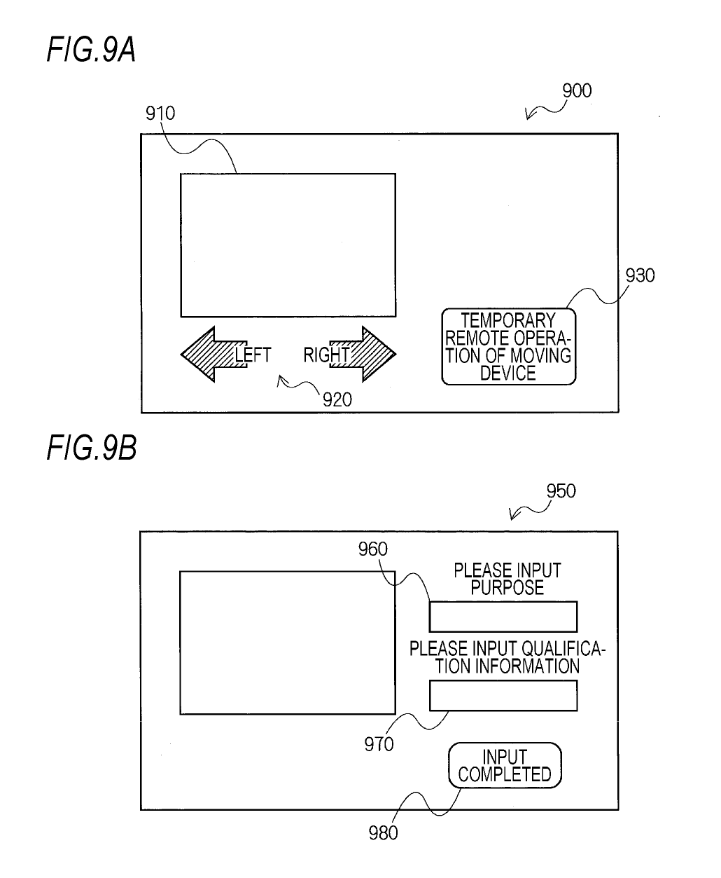

Here, FIG. 9A illustrates an example of a display screen 900 displayed on the display device that constitutes the user interface 404 of the first remote operation terminal device 41. For example, an image 910 captured by the side camera of the telepresence robot 20 is displayed on the display screen 900. Further, operation icons, for example, “right” and “left” for remotely operating the side camera are displayed on the display screen 900. When the first remote operator 45 operates the operation icon, the remote operation unit 422 of the first remote operation terminal device 41 generates remote camera control information in accordance with the first remote operator 45's operation on the user interface 404, and transmits the remote camera control information to the telepresence robot 20. The camera controller 222 of the telepresence robot 20 receives the remote camera control information, and controls the angle adjustment or the focal point adjustment of the side camera in accordance with the remote camera control information. Further, a temporary remote operation permission request button 930 for requesting permission of the temporary remote operation of the moving device 205 of the telepresence robot 20 is displayed on the display screen 900.

When the first remote operator 45 selects the temporary remote operation permission request button 930, the temporary operation authority request unit 423 of the first remote operation terminal device 41 displays an information input screen 950 illustrated in FIG. 9B on the display device of the user interface 404. A purpose input field 960 for inputting a purpose of the temporary remote operation of the moving device 205 and a qualification information input field 970 for inputting information about qualification owned by the first remote operator 45 are displayed on the information input screen 950. When the first remote operator 45 inputs required information into the information input screen 950 and then selects an input completion button 980, the temporary operation authority request unit 423 transmits, to the telepresence robot 20, the temporary operation authority permission request including information such as required user information, task contents, purposes, reasons, and qualification based on the input information.

In step S705 in FIG. 7, the temporary operation authority analyzing unit 227 determines whether the temporary operation authority permission request regarding the specific function is received from the remote operation terminal device 40. If the temporary operation authority permission request is not received, the process goes back to step S704, and the remote operation is continuously performed by the remote operation terminal device 40 having the general operation authorities for the respective functions. If the temporary operation authority permission request is received, the process goes to step S706. For example, in the present exemplary embodiment, if the temporary operation authority permission request for requesting the permission of the temporary remote operation of the movement controller 221 for controlling the moving device 205 of the telepresence robot 20 is received from the first remote operation terminal device 41, the process goes to step S706.

In step S706, referring to the operation authority listing database 229, the temporary operation authority analyzing unit 227 compares the information included in the temporary operation authority permission request with a condition for granting the temporary operation authority, that is, qualification of the remote operator, the intended use of the function, and reasons which are determined in the operation authority listing database 229.

In step S707, the temporary operation authority analyzing unit 227 determines whether the remote operator who has made the temporary operation authority permission request satisfies the condition for granting the temporary operation authority. If it is determined that the condition is not satisfied, the process goes to step S708. If it is determined that the condition is satisfied, the process goes to step S709.

In step S708, the temporary operation authority analyzing unit 227 transmits a message indicating that the temporary remote operation of the functions is not permitted, to the remote operation terminal device 40 which has made the temporary operation authority permission request. Further, specifically, in the present exemplary embodiment, if the first remote operator 45 does not satisfy the condition for temporarily remotely operating the moving device 205, the temporary operation authority analyzing unit 227 transmits information indicating that the temporary remote operation of the movement controller 221 for controlling the moving device 205 is not permitted, to the first remote operation device 41. Then, the process goes back to step S704.

In step S707, if it is determined that the remote operation terminal device 40 and the remote operator which have made the temporary operation authority permission request satisfy the condition for temporarily operating the function, the temporary operation authority analyzing unit 227, in step S709, transmits a confirmation request (hereinafter, referred to as a “temporary operation authority permission confirmation request”) as to whether to permit the temporary operation of the remote operation terminal device 40 operated by the remote operator who has the change authority regarding the operation authority, referring to the operation authority listing database 229. For example, in the present exemplary embodiment, the second remote operator 46 who operates the second remote operation terminal device 42 has the change authority to permit the temporary operation of the movement controller 221 of the telepresence robot 20. Thus, the temporary operation authority analyzing unit 227 transmits the temporary operation authority permission confirmation request to the second remote operation terminal device 42 operated by the second remote operator 46. Then, the process goes to step S710 in FIG. 8.

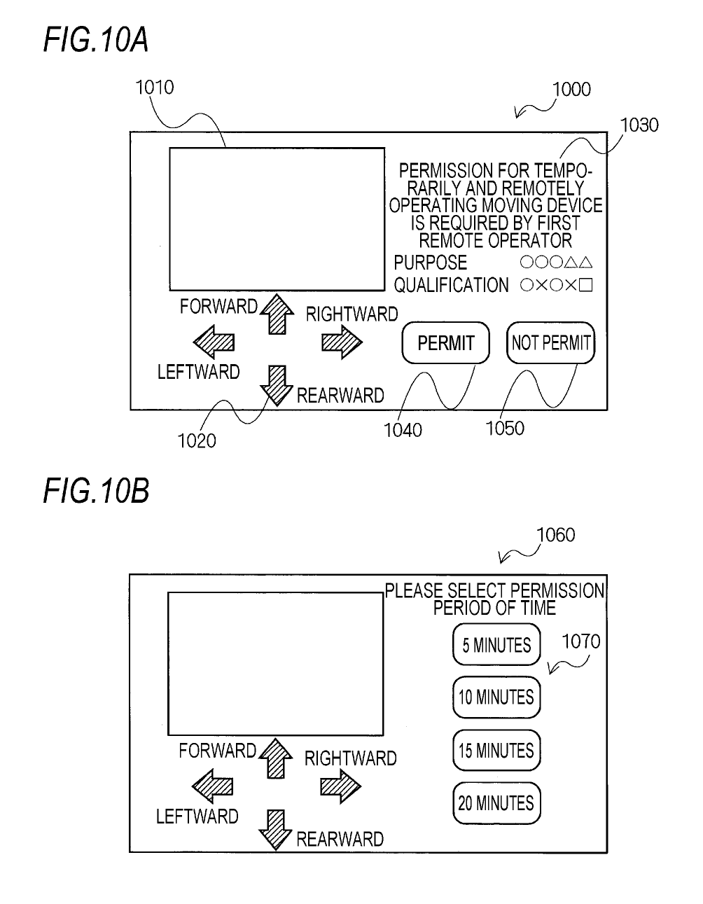

When the temporary operation authority permission confirmation request transmitted from the telepresence robot 20 is received in the second remote operation terminal device 42, the operation authority changing unit 424 of the second remote operation terminal device 42 displays the temporary operation authority permission confirmation screen on the display device that constitutes the user interface 404. FIG. 10A illustrates an example of a temporary operation authority permission confirmation screen 1000 displayed on the display device of the user interface 404 of the second remote operation terminal device 42. For example, an image 1010 which is captured by the main camera of the telepresence robot 20 is displayed on the temporary operation authority permission confirmation screen 1000. Further, operation icons 1020, for example, “forward,” “rearward,” “leftward,” “rightward,” and the like for remotely operating the moving device 205 of the telepresence robot 20 are displayed on the temporary operation authority permission confirmation screen 1000. When the second remote operator 46 operates these operation icons 1020, the moving device 205 is remotely operated by the movement controller 221 of the telepresence robot 20.

The temporary operation authority permission confirmation screen 1000 displays a message 1030 indicating that permission of the temporary remote operation of the moving device 205 is requested from the first remote operator 45, a permission icon 1040 for permitting the permission request, and a rejection icon 1050 for rejecting the permission request. If the second remote operator 46 selects the permission icon 1040, the operation authority changing unit 424 of the second remote operation terminal device 42 displays a permission period setting screen 1060 illustrated in FIG. 10B on the display device of the user interface 404 of the second remote operation terminal device 42. Period selection icons 1070 such as “5 minutes,” “10 minutes,” “15 minutes,” and “20 minutes” for selecting a period in which the temporary remote operation requested by the first remote operation terminal device 41 is permitted are displayed on the permission period setting screen 1060.

If the second remote operator 46 selects the icon indicating any of the periods, the operation authority changing unit 424 of the second remote operation terminal device 42 transmits, to the telepresence robot 20, (i) a reply indicating that the temporary operation authority permission request from the first remote operation terminal device 41 is permitted and (ii) the set validity period information. Meanwhile, as illustrated in FIG. 10A, if the second remote operator 46 selects the rejection icon 1050, the operation authority changing unit 424 of the second remote operation terminal device 42 transmits, to the telepresence robot 20, a reply indicating that the temporary operation authority permission request from the first remote operation terminal device 41 is rejected.

In step S710 in FIG. 8, the temporary operation authority analyzing unit 227 determines whether a reply of permission or rejection to the temporary operation authority permission confirmation request is received from the remote operation terminal device 40 operated by the remote operator who has the change authority of the operation authority. If the reply indicating that the temporary operation authority permission confirmation request is rejected is received, the process goes to step S711. If the reply indicating that the temporary operation authority permission confirmation request is permitted is received, the process goes to step S712.

In step S711, the temporary operation authority analyzing unit 227 transmits information indicating that the granting of the temporary operation authority is not permitted by the person who has the change authority, to the remote operation terminal device 40 which has made the temporary operation authority permission request. Then, the process goes back to step S704 in FIG. 7. In the present exemplary embodiment, a message indicating that the temporary remote operation of the movement controller 221 for controlling the moving device 205 of the telepresence robot 20 is not permitted by the remote operator 46 who has the authority to change the operation authority of the movement controller 221 is transmitted to the first remote operation terminal device 41.

In step S712, the temporary operation authority permitting unit 228 permits the temporary remote operation of the specific function by the remote operation terminal device 40 which has made the temporary operation authority permission request. In the present exemplary embodiment, the temporary remote operation of the movement controller 221 by the first remote operation terminal device 41 is accepted.

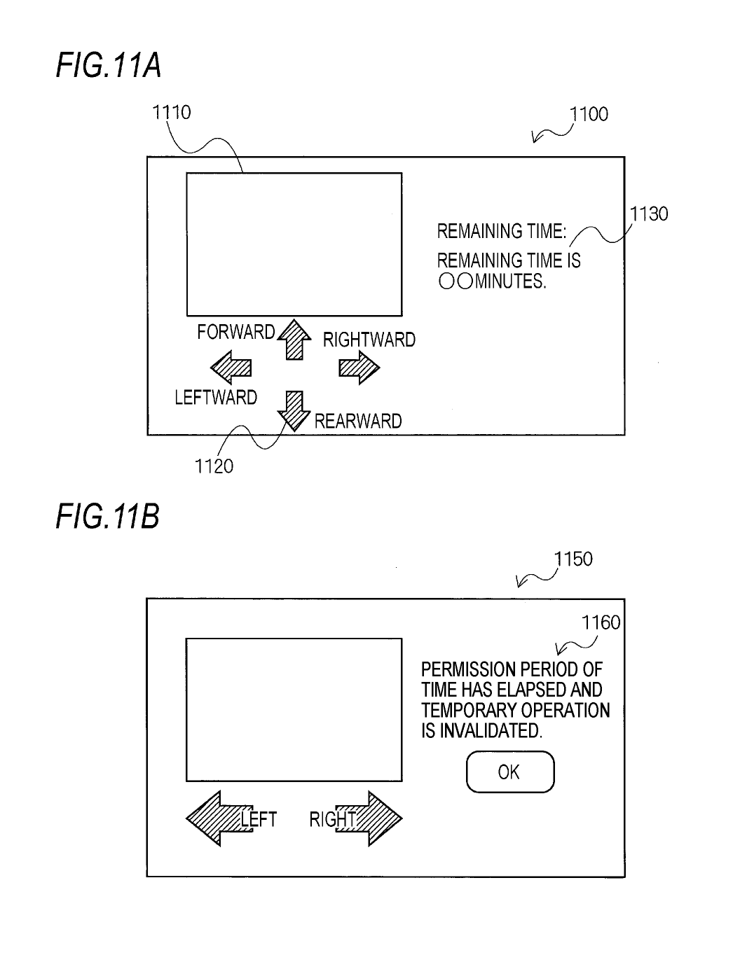

FIG. 11A is a view illustrating an example of the temporary remote operation screen 1100 for temporarily remotely operating the moving device 205 and the movement controller 221 of the telepresence robot 20, which is displayed on the display device of the user interface 404 of the first remote operation terminal device 41. Similarly to FIG. 9A, an image 1110 captured by the side camera of the telepresence robot 20 is displayed on the temporary remote operation screen 1100. This image 1110 is an image acquired from the camera 206 (side camera) by the camera controller 222 which is remotely operated by the first remote operator 45 having the general operation authority.

Operation icons 1120, for example, “forward,” “rearward,” “leftward,” “rightward,” and the like for temporarily remotely operating the moving device of the telepresence robot 20 are displayed on the temporary remote operation screen 1100. When the first remote operator 45 operates these operation icons 1120, the remote operation unit 422 of the first remote operation terminal device 41 generates remote movement control information for controlling the movement controller 221 of the telepresence robot 20, and transmits the remote movement control information to the telepresence robot 20. The movement controller 221 of the telepresence robot 20 receives the remote movement control information, and the moving device 205 is remotely operated in accordance with the remote movement control information. Further, a remaining time 1130 of the temporary remote operation permitted for the first remote operation terminal device 41 is displayed on the temporary remote operation screen 1100.

In step S713 in FIG. 8, the temporary operation authority permitting unit 228 determines whether a predetermined time elapses. For example, the predetermined time may be designated by the remote operator who has the change authority in response to the temporary operation permission confirmation request in steps S709 and S710, or the predetermined time maybe a value determined in advance in the operation authority listing database 229 of the telepresence robot 20. If the predetermined time has not elapsed, the process goes back to step S712, and the specific function is temporarily remotely operated until the predetermined time has elapsed. In the present exemplary embodiment, the movement controller 221 is temporarily remotely operated by the first remote operation terminal device 41 until the predetermined time has elapsed. If it is determined that the predetermined time has elapsed, the process goes to step S714.

In step S714, the temporary operation authority permitting unit 228 invalidates the temporary remote operation of the specific function, which has been temporarily permitted for the remote operation terminal device 40 up to that time, that is, makes the remote operation unavailable, and the process goes to step S715. In the present exemplary embodiment, the remote operation of the movement controller 221 by the first remote operation terminal device 41 is invalidated. That is, even if the remote movement control information is transmitted from the first remote operation terminal device 41, the control of the movement controller 221 is not performed accordingly.

In step S715, the temporary operation authority permitting unit 228 transmits, to the corresponding remote operation terminal device 40, a message indicating that the temporary remote operation of the specific function is invalidated. Then, the process goes back to step S704 in FIG. 7, and back to the remote operation by the remote operation terminal device 40 based on the general operation authority. In the present exemplary embodiment, the temporary operation authority permitting unit 228 transmits information indicating that the temporary remote operation of the moving device 205 is invalidated, to the first remote operation terminal device 41. FIG. 11B illustrates an example of a temporary remote operation ending screen 1150 which is displayed on the display device of the user interface 404 of the first remote operation terminal device 41 when the first remote operation terminal device 41 receives the information indicating that the temporary remote operation of the movement controller 221 is invalidated. A message 1160 indicating that the temporary remote operation is invalidated is displayed on the temporary remote operation ending screen 1150.

In the above example, the case where the movement controller 221 for controlling the moving device 205 of the telepresence robot 20 is temporarily remotely operated from the first remote operation terminal device 41 has been described. It should be noted that the exemplary embodiments of the present invention are not limited to this example. For example, the permission of the temporary remote operation of the side camera or the infrared camera of the camera 206 may be requested from the second remote operation terminal device 42. In addition, descriptions have been made on the example in which only the two remote operation terminal devices 40 are provided. It should be noted that the exemplary embodiments of the present invention are not limited to this example. The above exemplary embodiment is applicable to, for example, a case where three or more remote operation terminal devices 40 are provided. Further, a management server (not illustrated) may be connected to the telepresence robot 20 through the network 50, and the permission of the temporary remote operation of the specific function may be transmitted from the remote operation terminal device 40 to a manager who operates the management server.

Descriptions have been made on the example in which the temporary remote operation is canceled after the predetermined period of time has elapsed. Alternatively, the temporary remote operation may not be invalidated until the operation authority for the temporary remote operation is canceled by the remote operator who has the change authority. In addition, the following configuration may be adopted. That is, when the telepresence robot 20 moves in a predetermined region, the temporary remote operation of the moving device 205 is permitted, but when the telepresence robot 20 is about to be out of the predetermined region, the temporary remote operation of the moving device 205 is canceled, that is, the telepresence robot 20 does not move forward any further. Alternatively, when the telepresence robot 20 is about to be out of the predetermined region, the general operation of the specific function of the side camera or the like of which the remote operator has the general authority may become unavailable.

In a case where the second remote operator 46 who operates the second remote operation terminal device 42 has the general operation authority of the movement controller 221 for controlling the moving device 205 and the second remote operator 46 permits the first remote operator 45 to have the temporary operation authority of the movement controller 221 as described above, both of the first remote operator 45 and the second remote operator 26 may simultaneously remotely operate the movement controller 221 for controlling the moving device 205. Therefore, if the remote movement control information is simultaneously received from the two remote operation terminal devices, the remote operation from the remote operator who has the general operation authority or the change authority may be preferentially performed.

Descriptions have been made on the example in which the temporary operation authority of the movement controller 221 for controlling the movement of the moving device 205 of the telepresence robot 20 is temporarily granted to the first remote operator 45 who operates the first remote operation terminal device 41. It should be noted that the exemplary embodiments of the present invention are not limited to this example. The temporary operation authority of the camera controller 222 for controlling the camera 206 of the telepresence robot 20 or the temporary operation authority of a function of acquiring environment information around the telepresence robot 20, such as or the temporary operation authority of the environment information acquisition unit 223 for controlling the sensor 207 or controlling acquisition of information detected by the sensor maybe temporarily granted to the remote operator who does not have the general operation authority.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A robot control system comprising:
a remotely operated robot having a plurality of functions;
a permission unit configured to only permit a user having an operation authority for a specific function to remotely operate the specific function, among a plurality of users who remotely operate the remotely operated robot;
a receiver configured to receive a permission request for remotely operating the specific function from a user who does not have the operation authority for the specific function, among the users who remotely operate the remotely operated robot; and
an authority granting unit configured to grant the operation authority for the specific function to the user who has made the permission request, if a predetermined condition is satisfied upon receiving the permission request.

2. The robot control system according to claim 1, wherein the permission unit is configured to simultaneously permit different users to remotely operate the plurality of functions of the remotely operated robot, respectively.

3. The robot control system according to claim 1, wherein the plurality of users are simultaneously allowed to remotely operate of the respective plural functions of the remotely operated robot.

4. The robot control system according to claim 1, wherein the authority granting unit is configured to grant the operation authority for the specific function to the user who has made the permission request, only for a predetermined period of time.

5. The robot control system according to claim 1, wherein the authority granting unit is configured to invalidate the operation authority for the specific function granted to the user who has made the permission request, after a predetermined period of time has elapsed.

6. The robot control system according to claim 1, wherein if the remotely operated robot is present in a predetermined region, the permission unit permits the user who has made the permission request to remotely operate the specific function.

7. The robot control system according to claim 1, wherein if the remotely operated robot is present in a predetermined region, the permission unit prohibits the user who has made the permission request from remotely operating the specific function.

8. The robot control system according to claim 1, wherein the specific function is a movement control function of controlling a movement of the remotely operated robot.

9. The robot control system according to claim 2, wherein the specific function is a movement control function of controlling a movement of the remotely operated robot.

10. The robot control system according to claim 3, wherein the specific function is a movement control function of controlling a movement of the remotely operated robot.

11. The robot control system according to claim 4, wherein the specific function is a movement control function of controlling a movement of the remotely operated robot.

12. The robot control system according to claim 5, wherein the specific function is a movement control function of controlling a movement of the remotely operated robot.

13. The robot control system according to claim 6, wherein the specific function is a movement control function of controlling a movement of the remotely operated robot.

14. The robot control system according to claim 7, wherein the specific function is a movement control function of controlling a movement of the remotely operated robot.

15. The robot control system according to claim 8, wherein
the plurality of users include a first user and a second user, and
if the first user remotely operates the movement control function, the second user remotely operates a function other than the movement control function.

16. The robot control system according to claim 1, wherein the specific function is a function of acquiring environment information around the remotely operated robot.

17. A robot control system comprising:
a remotely operated robot having a plurality of functions;
permission means for only permitting a user having an operation authority for a specific function to remotely operate the specific function, among a plurality of users who remotely operate the remotely operated robot;
receiving means for receiving a permission request for remotely operating the specific function from a user who does not have the operation authority for the specific function, among the users who remotely operate the remotely operated robot; and
authority granting means for granting the operation authority for the specific function to the user who has made the permission request, if a predetermined condition is satisfied upon receiving the permission request.
